(19) United States
(12) Patent Application Publication
(10) Pub. No.: US 2024/0300768 A1
(43) Pub. Date: Sep. 12, 2024

(54) WRAPPER CUTTER

(71) Applicant: Yong LIU, Yiwu (CN)

(72) Inventor: Yong LIU, Yiwu (CN)

(21) Appl. No.: 18/119,848

(22) Filed: Mar. 10, 2023

(51) Int. Cl. B65H 35/06; B26D 7/14

(52) U.S. Cl. CPC B65H 35/06; B26D 7/14; B65H 2301/122; B65H 2701/1944

(57) ABSTRACT

A wrapper cutter includes a shell, and the shell includes a second shell and a first shell with a polygonal track structure. The wrapper cutter further includes: an open slot, one side of which is provided with a notch extending along a vertical direction; a cutting knife, fixed on the inner bottom wall of the notch; a rhombic indwelling notch, arranged at one side of the cutting knife; a fixed plate, configured for forcibly bending an introduced wrapper into an arc-shaped surface, so that the wrapper passing through the cut position reaches a maximum stiffness and tension; parallel guideways, a limiting slope for allowing the rolled wrapper to abut against the cutting knife being arranged between the parallel guideways. By adopting a polygonal three-dimensional supporting structure and the fixed plate, the rolled wrapper can reach a maximum tension, and hits the cutting edge to generate a maximum lateral component force.

### TECHNICAL FIELD

The present invention belongs to the field of cutter technology, and in particular relates to a wrapper cutter.

### BACKGROUND

When cutting a rolled wrapper, a pair of scissors or a utility knife is usually used for cutting. However, when the pair of scissors or the utility knife is used to cut the wrapper, it is difficult to cut the rolled wrapper along a straight line, so wrapper cutters appear in the market. However, the wrapper cutters in the market are all of a cylindrical, simple structure, which is poor in cutting effect, cannot ensure the successful cutting of wrappers, and may lead to uneven cut faces. Therefore, a wrapper cutter is proposed.

### SUMMARY

The objective of the present invention is to provide a wrapper cutter in order to solve the problems raised in the above background.

The embodiment of the present invention is implemented in a way that the wrapper cutter comprises a shell and a cutting knife, the shell being of a hollow structure that runs through from top to bottom, wherein the shell comprises a first shell and a second shell, the first shell being of a polygonal track structure, and the shape of the second shell being matched with the shape of a rolled wrapper, and further comprises:
an open slot, arranged running through from top to bottom in the shell, one side of the open slot being provided with a notch extending along a vertical direction, the open slot being communicated with the notch, and the cutting knife being arranged fixedly on the inner bottom wall of the notch;
a rhombic indwelling notch, arranged at one side of the cutting knife;
a fixed plate, arranged fixedly on one side of the first shell close to the open slot, and configured for bending the introduced wrapper into an arc-shaped surface, so that the wrapper passing through the cut position can reaches a maximum stiffness and tension; and
parallel guideways, arranged on the first shell, and a limiting slope being arranged between the parallel guideways, and the limiting slope being configured for making the rolled wrapper abut against the cutting knife.

Further, the upper end of the fixed plate is arranged obliquely in a direction from the open slot to the notch.

Further, the cutting edge of the cutting knife is arranged obliquely in the notch.

Further, the wrapper cutter also comprises a vertical plate, which is arranged fixedly on the sidewall of the notch close to the open slot and the upper end of which is arranged obliquely in a direction from the open slot to the notch.

Further, a hilt is fixedly connected to the shell.

Compared with the prior art, the present invention has the following beneficial effects:

Because the wrapper cutter adopts a polygonal three-dimensional supporting structure, with the cooperation of the fixed plate, the rolled wrapper reaches the maximum tension, and then hits the cutting edge to generate a maximum lateral component force, and the wrapper which is not cut apart in the first place can be cut by climbing for the second time until the rolled wrapper is cut apart, and thereby, it can be ensured that the rolled wrapper can be cut; with the cooperation of the parallel guideways, the cut of the rolled wrapper is a straight line, which is even and aesthetic; and by setting the limiting slope, the roll wrapper can always abut against the blade when cut even though the diameter is changing, so that a best cutting effect can be achieved.

### BRIEF DESCRIPTION OF THE DRAWINGS

FIG. 1 is a schematic structural diagram of a wrapper cutter.

FIG. 2 is a schematic structural bottom view of the wrapper cutter.

FIG. 3 is a schematic structural top view of the wrapper cutter.

FIG. 4 is a schematic three-dimensional structural diagram of the wrapper cutter.

FIG. 5 is an enlarged schematic structural diagram of the wrapper cutter in area A in FIG. 3.

In the accompanying drawings: Shell 01; First shell 11; Second shell 12; Limiting slope 13; Parallel guideway 14; Hilt 02; Open slot 03; Cutting knife 04; Rhombic indwelling notch 05; Fixed plate 06; Vertical plate 07; Notch 08.

### DETAILED DESCRIPTION OF THE EMBODIMENTS

In order to make the objective, technical solution and advantages of the present invention clearer, the present invention will be further described in detail below with reference to the accompanying drawings and embodiments. It should be understood that the specific embodiments described herein are merely intended to explain the present invention rather than limit the present invention.

The specific implementation of the present invention will be described in detail below in conjunction with specific embodiments.

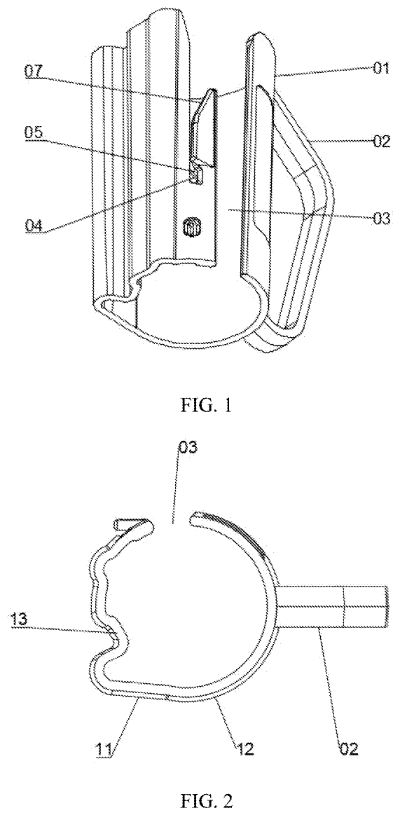

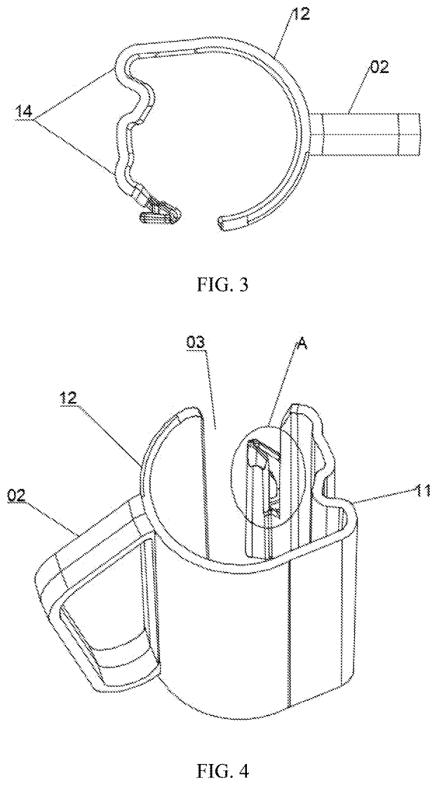

As shown in FIGS. 1 to 5, an embodiment of the present invention provides a wrapper cutter, which includes a shell 01 and a cutting knife 04, the shell 01 being of a hollow structure that runs through from top to bottom, the shell 01 including a first shell 11 and a second shell 12, the first shell 11 being of a polygonal track structure, and the shape of the second shell 12 being matched with the shape of a rolled wrapper, and further includes:
an open slot 03, arranged running through from top to bottom in the shell 01, one side of the open slot 03 being provided with a notch 08 extending along a vertical direction, the open slot 03 being communicated with the notch 08, and the cutting knife 04 being arranged fixedly on the inner bottom wall of the notch 08;
a rhombic indwelling notch 05, arranged at one side of the cutting knife 04;
a fixed plate 06, arranged fixedly on one side of the first shell 11 close to the open slot 03, and configured for bending the introduced wrapper into an arc-shaped surface, so that the wrapper passing through the cut position can reaches a maximum stiffness and tension; and
parallel guideways 14, arranged on the first shell 11, and a limiting slope 13 being arranged between the parallel guideways 14, and the limiting slope 13 being configured for making the rolled wrapper abut against the cutting knife 04.

In the embodiment of the present invention, the rolled wrapper is introduced into the shell 01, and the fixed plate 06 bends the rolled wrapper into an n-shaped arch according to the shape of an arc, so that the rolled wrapper reaches the maximum tension and hits the cutting edge of the cutting knife 04 at an angle of 40 degrees to generate a maximum lateral component force. If the rolled wrapper is not cut apart in the first place, the rhombic indwelling notch 05 is intended to make the rolled wrapper bend into the n-shaped arch for the second time in cooperation with the first shell 11 and climb along the slope of the rhombic indwelling notch 05, so that the cutting knife 04 continues to cut the rolled wrapper until the rolled wrapper is cut apart. By arranging the first shell 11 of the shell 01 into a polygonal track structure, the shape of the second shell 12 of the shell 01 is matched with the shape of the rolled wrapper, so that the rolled wrapper can be clamped and attached to the cut, and thereby, the rolled wrapper can reach the maximum tension, achieving a best cutting effect.

The parallel guideways 14 which are shaped like a sled can slide linearly along the rolled wrapper. Since the rolled wrapper is straight, the parallel guideways 14 will only slide linearly, so that the cut face of the wrapper can appear as a straight line. The sidewall of the limiting slope 13 close to the second shell 12 is arranged obliquely in a direction from the junction between the first shell 11 and the second shell 12 to the open slot 03. Since the rolled wrapper becomes less and less, under the function of the limiting slope 13, the rolled wrapper (the diameter of the rolled wrapper is less than 5.5 cm) can always abut against the blade when cut even though the diameter is changing, so that a best cutting effect is achieved.

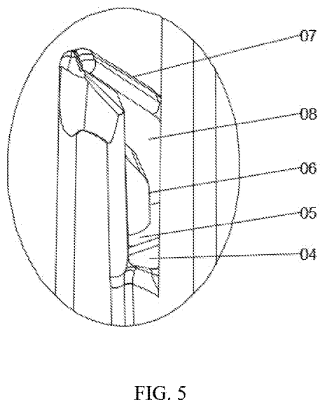

As shown in FIGS. 4 and 5, as a preferred embodiment of the present invention, the upper end of the fixed plate 06 is arranged obliquely from the open slot 03 to the notch 08.

In the embodiment of the present invention, the fixed plate 06 can forcibly bend the introduced wrapper into an arc-shaped surface, so that the wrapper passing through the cut position can reach the maximum stiffness and tension, making it convenient for the rolled wrapper to hit the cutting edge of the cutting knife 04 to generate the maximum lateral component force.

As shown in FIGS. 1 and 5, as a preferred embodiment of the present invention, the cutting edge of the cutting knife 04 is arranged obliquely in the notch 08.

In the embodiment of the present invention, the oblique arrangement of the cutting edge of the cutting knife 04 facilitates the cutting of the rolled wrapper.

As shown in FIGS. 4 and 5, as a preferred embodiment of the present invention, the wrapper cutter also includes a vertical plate 07, which is arranged fixedly on the sidewall of the notch 08 close to the open slot 03, and the upper end of the vertical plate 07 is arranged obliquely in a direction from the open slot 03 to the notch 08.

In the embodiment of the present invention, during use, the wrapper cutter is attached to the desktop and pushed along the direction of the rolled wrapper, so that the rolled wrapper can be easily and perfectly cut apart.

As shown in FIG. 1, as a preferred embodiment of the present invention, a hilt 02 is connected fixedly to the shell 01.

In the embodiment of the present invention, during use, a hand holds the hilt 02 to push the wrapper cutter, so the wrapper cutter is convenient to use.

The operating principle of the present invention is as follows:

According to the wrapper cutter, the rolled wrapper is introduced into the shell 01 and bent into an n-shaped arch according to the shape of an arc, so that the rolled wrapper reaches the maximum tension and hits the cutting edge of the cutting knife 04 at an angle of 40 degrees to generate a maximum lateral component force; if the rolled wrapper is not cut apart in the first place, the rhombic indwelling notch 05 is intended to make the rolled wrapper bend into the n-shaped arch for the second time in cooperation with the vertical plate 07 and the first shell 11 and climb along the slope of the rhombic indwelling notch 05, so that the cutting knife 04 continues to cut the rolled wrapper until the rolled wrapper is cut apart; by arranging the parallel guideways 14, the cut face of the wrapper can appear as a straight line; by arranging the limiting slope 13, the rolled wrapper can always abut against the blade when cut even though the diameter is changing, so that a best cutting effect is achieved.

The above is merely the preferred embodiments of the present invention. It should be pointed out that for those skilled in the art, some modifications and improvements can be made without departing from the concept of the present invention, which should also be regarded as being within the protection scope of the present invention and will not affect the implementation effect of the present invention and the practicality of the patent.

What is claimed is:

1. A wrapper cutter, comprising:
a shell and a cutting knife, wherein the shell is of a hollow structure, and the hollow structure runs through from top to bottom, wherein
the shell comprises a first shell and a second shell, wherein the first shell is of a polygonal track structure, and a shape of the second shell is matched with a shape of a rolled wrapper;
an open slot, wherein the open slot is arranged running through from top to bottom in the shell, one side of the open slot is provided with a notch extending along a vertical direction, the open slot is communicated with the notch, and the cutting knife is arranged fixedly on an inner bottom wall of the notch;
a rhombic indwelling notch, wherein the rhombic indwelling notch is arranged at one side of the cutting knife;
a fixed plate, wherein the fixed plate is arranged fixedly on a side of the first shell, wherein the side of the first shell is adjacent to the open slot; and the fixed plate is configured for bending an introduced wrapper into an arc-shaped surface, so that a wrapper passing through a cut position reaches a maximum stiffness and tension; and
parallel guideways, wherein the parallel guideways are arranged on the first shell, a limiting slope is arranged between the parallel guideways, and the limiting slope is configured for allowing the rolled wrapper to abut against the cutting knife.

2. The wrapper cutter of claim 1, wherein an upper end of the fixed plate is arranged obliquely in a direction from the open slot to the notch.

3. The wrapper cutter of claim 2, wherein a cutting edge of the cutting knife is arranged obliquely in the notch.

4. The wrapper cutter of claim 1, further comprising a vertical plate, wherein
the vertical plate is arranged fixedly on a sidewall of the notch, wherein the sidewall of the notch is adjacent to the open slot; and
an upper end of the vertical plate is arranged obliquely in a direction from the open slot to the notch.

5. The wrapper cutter of claim 1, wherein a hilt is connected fixedly to the shell.
